(19) United States
(12) Patent Application Publication
(10) Pub. No.: US 2026/0244747 A1
(43) Pub. Date: Aug. 20, 2026

(54) PROCESS FLOW VISUALIZATION APPARATUS, PROCESS FLOW VISUALIZATION METHOD, AND PROCESS FLOW VISUALIZATION PROGRAM

(71) Applicant: NEC Corporation, Tokyo (JP)

(72) Inventor: Daichi ARAI, Tokyo (JP)

(73) Assignee: NEC Corporation, Tokyo (JP)

(21) Appl. No.: 19/164,254

(22) PCT Filed: Mar. 23, 2023
(86) PCT No.: PCT/JP2023/011428

§ 371 Date: Sep. 11, 2025

(51) Int. Cl. G06F 21/56; G06T 11/26

(52) U.S. Cl. CPC G06F 21/56; G06T 11/26; G06F 2221/033

(57) ABSTRACT

A process flow visualization apparatus includes: a path database that stores control path(s) between a start point(s) and an end point(s) in a program(s) and propagation path(s) between two base points in the control path(s); a code database that stores code having an association(s) with each element stored in the path database; and a code display part that acquires propagation path(s) relevant to focused base point(s) from the path database, extracts part(s) of code from the code database based on the propagation path(s), and displays the extracted code.

### TECHNICAL FIELD

The present invention relates to a process flow visualization apparatus, process flow visualization method, and process flow visualization program.

### BACKGROUND

As one of measures for supply chain risk management, detection of malicious functions within software, known as backdoors, has become increasingly important. Current computer systems have become so complex that it is difficult to configure them using only products from a single company. Therefore, it is common to procure parts externally and assemble the procured parts to configure a system. In this process, the manufacturers of the procured parts and the supply chains are assumed to be trustworthy because backdoor detection is required as part of the process.

However, detecting backdoors in software requires significant time and effort without having source code since such a task would entail reverse engineering, analyzing suspicious functions and execution paths in detail, and manually sifting them through to find backdoors. To address this, for instance, Patent Literature 1 proposes a technique that visualizes data/control dependency propagation for each variable in a program by displaying it as a graph or tree structure and highlighting statements in source code that correspond to a selected variable.

### CITATION LIST

### Patent Literature 1

Japanese Patent No. 5775829

### SUMMARY

### Technical Problem

The disclosure of each literature cited above is incorporated herein in its entirety by reference thereto. The following analysis is provided by the present inventors.

Although there are tools available to support backdoor detection, data/control dependency propagation of variables within a program is highly complex, and the number of propagation paths between variables increases exponentially with their length, making it difficult to examine all possible propagation routes. As a result, identifying condition variables used in control instructions that may trigger a backdoor becomes a time-consuming task.

It is therefore necessary to visualize processing flows in a program, from processes of receiving external inputs (src) to operations that could have a significant impact on a system (sink), in a way that allows for easy investigation of their potential danger (likelihood of a backdoor). This risk can be assessed by tracing propagation of variables to determine how condition variables used in control instructions that may potentially trigger a backdoor were calculated.

In view of the problem above, it is an object of the present invention to provide a process flow visualization apparatus, process flow visualization method, and process flow visualization program that contribute to facilitating investigation of software.

### Solution to Problem

According to a first aspect of the present invention, there is provided a process flow visualization apparatus including: a path database that stores control path(s) between a start point(s) and an end point(s) in a program(s) and propagation path(s) between two base points in the control path (s); a code database that stores code having an association(s) with each element stored in the path database; and a code display part that acquires propagation path(s) relevant to focused base point(s) from the path database, extracts part(s) of code from the code database based on the propagation path(s), and displays the extracted code.

According to a second aspect of the present invention, there is provided a process flow visualization method performed by an information processing apparatus including a path database that stores control path(s) between a start point(s) and an end point(s) in a program(s) and propagation path(s) between two base points in the control path(s), a code database that stores code having an association(s) with each element stored in the path database; and a code display part, the process flow visualization method including: acquiring propagation path(s) relevant to focused base point(s) from the path database; and extracting part(s) of code from the code database based on the propagation path(s) and displaying the extracted code on the code display part.

According to a third aspect of the present invention, there is provided a process flow visualization program executed by an information processing apparatus including a path database that stores control path(s) between a start point(s) and an end point(s) in a program(s) and propagation path(s) between two base points in the control path(s), a code database that stores code having an association(s) with each element stored in the path database; and a code display part, the process flow visualization program causing the information processing apparatus to execute: a process of acquiring propagation path(s) relevant to focused base point(s) from the path database; and a process of extracting part(s) of code from the code database based on the propagation path(s) and displaying the extracted code on the code display part.

Further, the program(s) can be stored in a computer-readable storage medium. The storage medium may be a non-transitory one such as a semiconductor memory, a hard disk, a magnetic recording medium, an optical recording medium, and the like. The present invention can also be realized as a computer program product.

### Advantageous Effects of Invention

According to each aspect of the present invention, there can be provided a process flow visualization apparatus, process flow visualization method, and process flow visualization program that contribute to facilitating investigation of software.

### BRIEF DESCRIPTION OF DRAWINGS

FIG. 1 is a schematic diagram illustrating a basic configuration of a flow visualization apparatus relating to an example embodiment.

FIG. 2 is a diagram illustrating a control path and propagation paths.

FIG. 3 is a diagram illustrating control dependency propagation in a control path.

FIG. 4 is a diagram illustrating data dependency propagation in a propagation path.

FIG. 5 is a diagram showing an example of a list of base points used to select focused base point(s).

FIG. 6 is a diagram illustrating a procedure from selecting a focused base point(s) to displaying partial code.

FIG. 7 is a diagram illustrating a mechanism by which the number of investigated paths can be reduced.

FIG. 8 is a diagram illustrating a hardware configuration example of the flow visualization apparatus used in the example embodiment.

### EXAMPLE EMBODIMENTS

The following describes an example embodiment of the present invention with reference to the drawings. The present invention, however, is not limited to the example embodiment described below. Further, in each drawing, the same or corresponding elements are appropriately designated by the same reference signs. It should be noted that the drawings are schematic, and the dimensional relationships and the ratios between the elements may differ from the actual ones. The dimensional relationships and the ratios between the drawings may also be different in some sections.

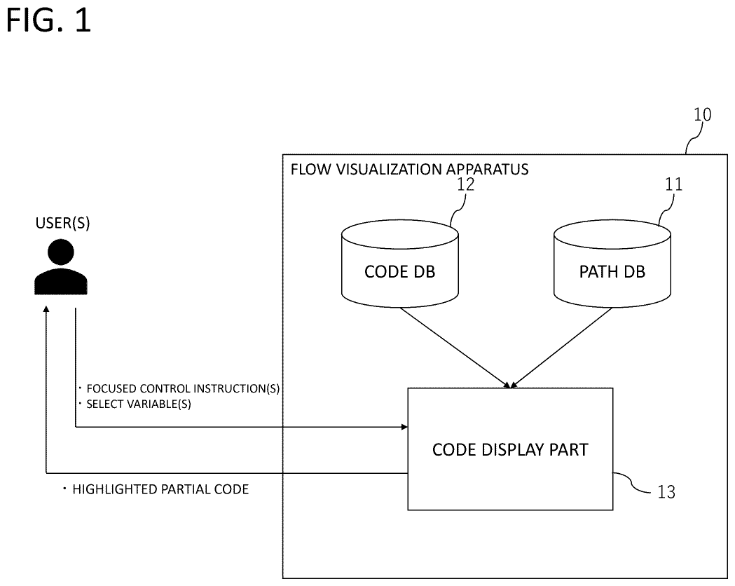

FIG. 1 is a schematic diagram illustrating a basic configuration of a flow visualization apparatus relating to the example embodiment. As shown in FIG. 1, the flow visualization apparatus 10 includes a path database 11, a code database 12, and a code display part 13. The path database 11 stores control path(s) between a start point(s) and an end point(s) in a program(s) and propagation path(s) between two base points in the control path(s). The code database 12 stores code having an association(s) with each element stored in the path database. The code display part 13 acquires propagation path(s) relevant to focused base point(s) from the path database 11, extracts part(s) of code from the code database 12 based on the propagation path(s), and displays the extracted code. The code stored in the code database 12 is preferably source code, but it is not limited thereto and may be assembly code, intermediate code, bytecode, etc.

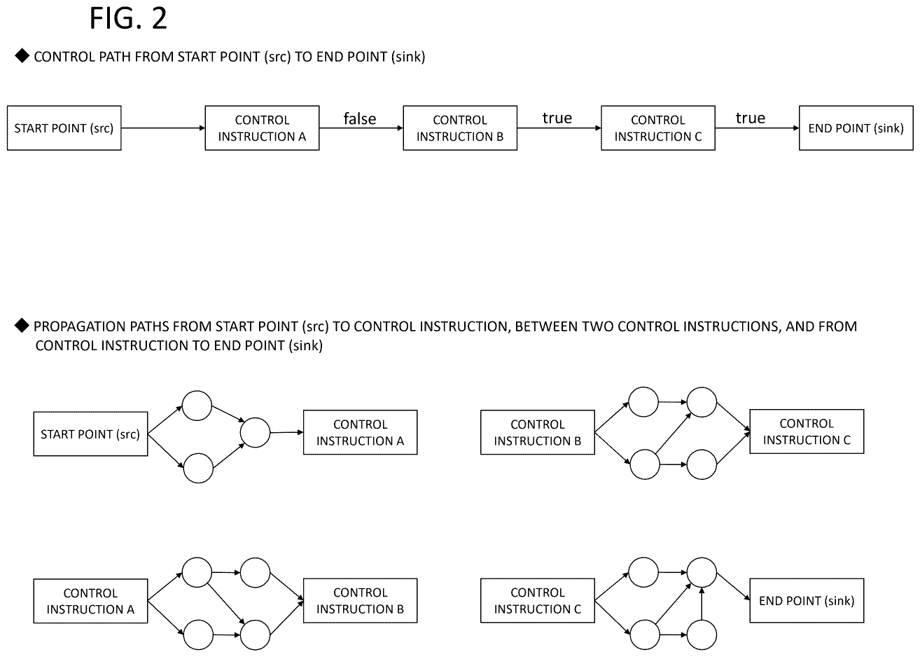

FIG. 2 is a diagram illustrating a control path and propagation paths. As shown in FIG. 2, a control path is a flow of control instruction(s) that connects a start point (src) to an end point (sink). The start point (src) is a process of receiving external input(s) while the end point (sink) is a process that can have a significant impact on a system. Therefore, in a flow of control instruction(s) that connects a start point (src) to an end point (sink), any unexpected control instruction may pose a potential risk as a trigger that activates a backdoor.

Meanwhile, as illustrated in FIG. 2, a propagation path is a flow that indicates variable dependency/dependencies between two base points in a control path. Here, since base point(s) in a control path includes a start point (src), an end point (sink), or control instruction(s), propagation paths between two base points in the control path include a propagation path from the start point (src) to a control instruction, one between two control instructions, and one from a control instruction to the end point (sink). In the example of the control path shown in FIG. 2, propagation paths between the start point (src) and a control instruction A, between the control instruction A and a control instruction B, between the control instruction B and a control instruction C, and from the control instruction C to the end point (sink) are flows between two base points in the control path. The path database 11 stores control path(s) indicating variable dependency/dependencies between given start and end points in a program(s) and propagation path(s) between any two base points in the control path(s), as illustrated in FIG. 2.

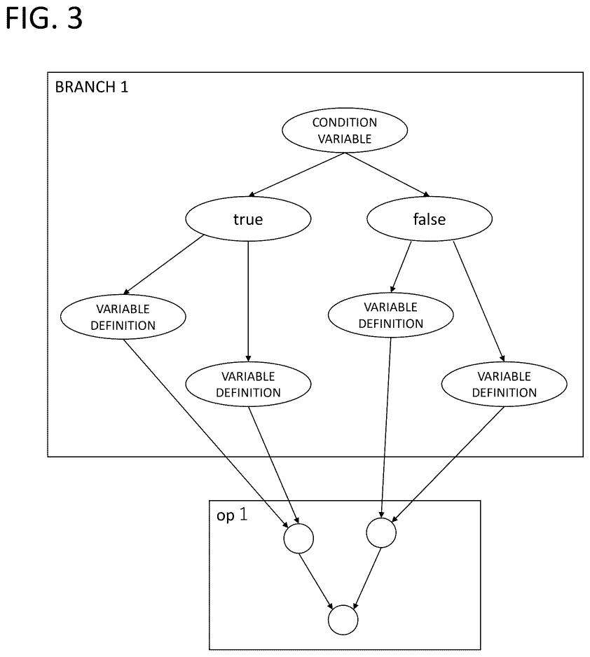

FIG. 3 is a diagram illustrating control dependency propagation in a control path. As shown in FIG. 3, control dependency propagation refers to propagation that transitions from a condition variable according to truth value(s). The control path shown in FIG. 2 is a flow that indicates control dependency propagation through the control instructions connecting the start point (src) to the end point (sink).

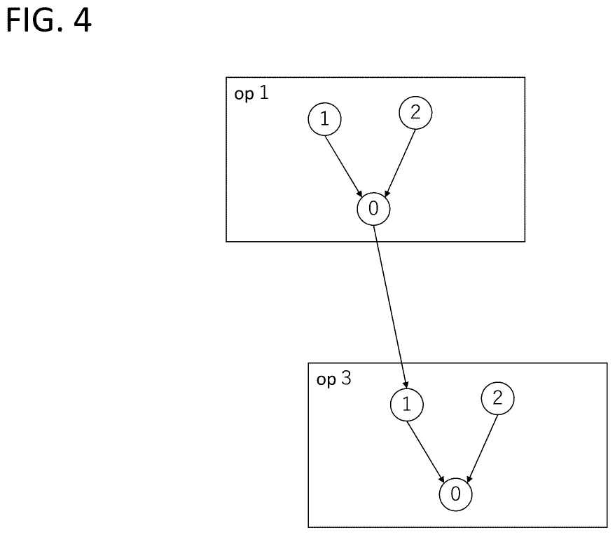

FIG. 4 is a diagram illustrating data dependency propagation in a propagation path. As shown in FIG. 4, variables in the propagation path have a data-dependent propagation relationship. In the example illustrated in FIG. 4, variables “param1” and “param2” in an operation “op1” propagate to a variable “param0,” and the variable “param0” in the operation “op1” further propagates to a variable “param1” in an operation “op3.” The propagation paths shown in FIG. 2 are also flows that connect the start point (src) and the control instruction A, the control instructions A and B, the control instructions B and C, and the control instruction C and the end point (sink) through data-dependency propagation between variables.

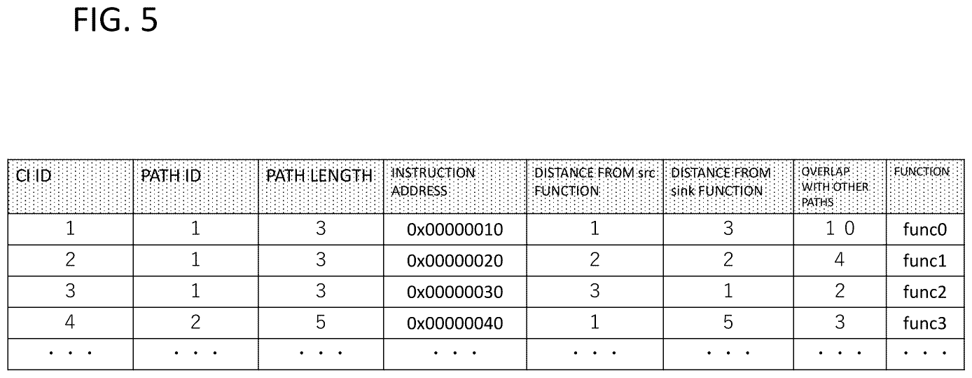

FIG. 5 is a diagram showing an example of a list of base points used to select focused base point(s). Since base point(s) in a control path includes a start point (src), an end point (sink), or control instruction(s), focused base point(s) can effectively be understood as focused control instruction(s). As previously described, the code display part 13 acquires propagation path(s) relevant to focused base point(s) from the path database 11, extracts part(s) of code from the code database 12 based on the propagation path(s), and displays the extracted code. While it is possible for a user(s) to specify focused base points using input device(s) such as a keyboard, from a usability standpoint, it is preferable to present a list such as the one shown in FIG. 5 and have the user(s) select from the list.

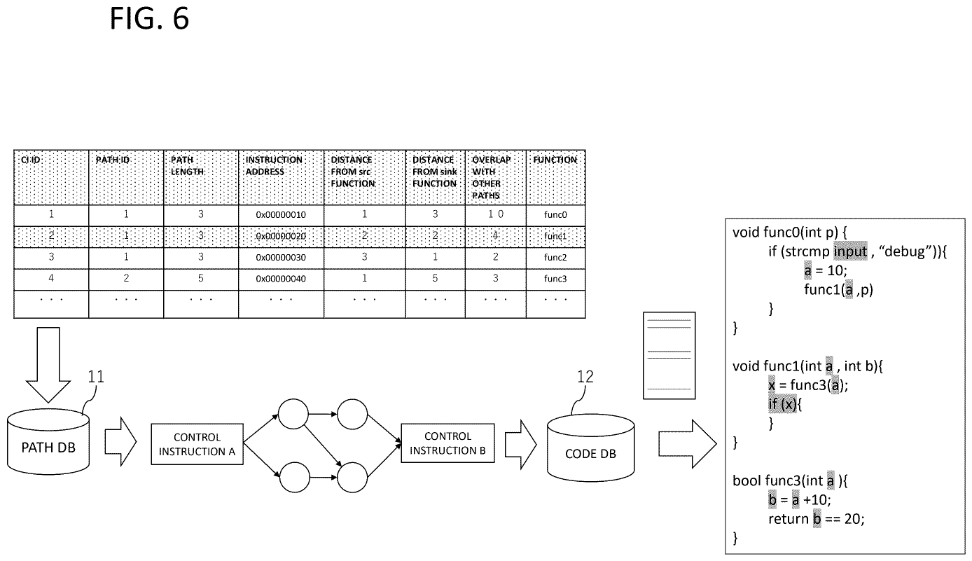

FIG. 6 is a diagram illustrating a procedure from selecting a focused base point(s) to displaying partial code. As previously stated, the code display part 13 acquires propagation path(s) relevant to focused base point(s) from the path database 11, extracts part(s) of code from the code database 12 based on the propagation path(s), and displays the extracted code. A focused base point(s) (control instruction(s)) is selected from a list, as noted above. Next, the code display part 13 acquires control path(s) relevant to a selected focused base point(s) (control instruction(s)) from the path database 11, and then obtains a propagation path(s) between the selected base point(s) and an immediately preceding base point(s) in the control path(s). The code display part 13 then extracts a portion(s) of code corresponding to the propagation path(s) from the code database 12 and displays the extracted code. At this time, as shown in FIG. 6, the focused control instruction(s) and each variable in the propagation path(s) are highlighted to assist in investigating whether the control instruction(s) in question may potentially serve as a backdoor trigger.

Further, it is preferable that the code display part 13 acquire a direct source(s) of dependency for element(s) in a propagation path(s) corresponding to a selected variable(s) in the code and highlight corresponding element(s) in the code. By successively selecting directly depended variable(s), which are highlighted, from condition variable(s), the user(s) can trace how each conditional variable is computed, enabling efficient investigation into whether it is a potential backdoor trigger.

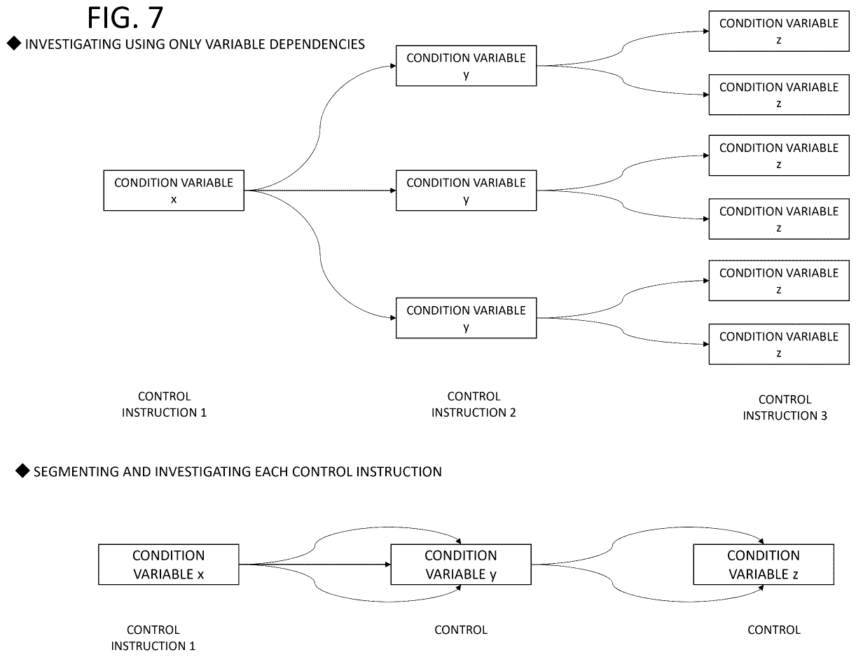

According to the flow visualization apparatus 10 relating to the example embodiment of the present invention, by tracing dependency/dependencies only between control instructions, it is possible to reduce the number of paths to be investigated. FIG. 7 is a diagram illustrating a mechanism by which the number of investigated paths can be reduced. As shown in FIG. 7, since variable dependencies may involve a plurality of paths between control instructions, the number of paths increases exponentially when each control instruction is examined. However, if each control instruction is segmented and investigated, even with a plurality of paths existing between control instructions, the number of paths increases only linearly for each control instruction since paths are not traced across control instruction(s). Consequently, the flow visualization apparatus 10 relating to the example embodiment of the present invention can reduce the number of paths to be investigated during backdoor detection.

### Hardware Configuration

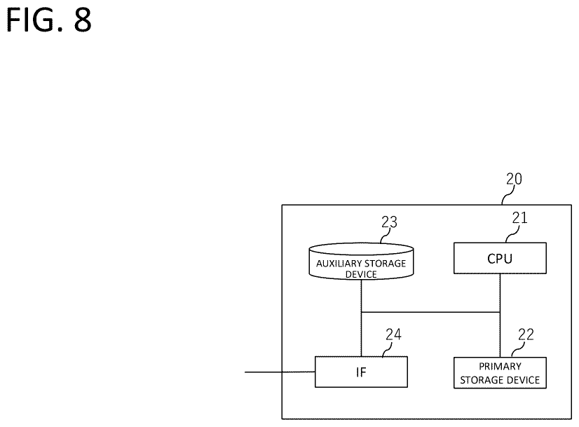

FIG. 8 is a diagram illustrating a hardware configuration example of the flow visualization apparatus used in the example embodiment. In other words, the flow visualization apparatus 10 is able to achieve each function thereof by causing an information processing apparatus (computer) 20 employing the hardware configuration shown in FIG. 8 to execute the flow visualization method described above as a program(s). It should be noted that the hardware configuration example shown in FIG. 8 is merely an example of the hardware configuration that achieves each function of the flow visualization apparatus 10 and is not intended to limit the hardware configuration of the flow visualization apparatus 10. The flow visualization apparatus 10 may include hardware not shown in FIG. 8.

As shown in FIG. 8, the hardware configuration that may be employed by the flow visualization apparatus 10 includes a CPU (Central Processing Unit) 21, a primary storage device 22, an auxiliary storage device 23, and an IF (interface) part 24, which are connected to each other by, for instance, an internal bus.

The CPU 21 executes each instruction included in the flow visualization program executed by the information processing apparatus (computer) 20. The primary storage device 22 is, for instance, a RAM (Random Access Memory) and temporarily stores various programs such as the process flow visualization program executed by the information processing apparatus (computer) 20 so that the CPU 21 can process the program(s).

The auxiliary storage device 23 is, for instance, an HDD (Hard Disk Drive) and is capable of storing various programs, such as the process flow visualization program executed by the information processing apparatus (computer) 20, in the medium to long term. Various programs such as the process flow visualization program may be provided as a program product(s) stored in a non-transitory computer-readable storage medium.

The IF part 24 provides an interface related to, for instance, an input and output of the flow visualization apparatus 10.

The information processing apparatus (computer) 20 employing the hardware configuration described above achieves each function of the flow visualization apparatus 10 by executing the flow visualization method described above as a program.

Part or entirety of the example embodiment above can be described as (but not limited to) the following Supplementary Notes.

### [Supplementary Note 1]

A process flow visualization apparatus, comprising:
a path database that stores control path(s) between a start point(s) and an end point(s) in a program(s) and propagation path(s) between two base points in the control path (s);
a code database that stores code having an association(s) with each element stored in the path database; and
a code display part that acquires propagation path(s) relevant to focused base point(s) from the path database, extracts part(s) of code from the code database based on the propagation path(s), and displays the extracted code.

### [Supplementary Note 2]

The process flow visualization apparatus according to Supplementary Note 1, wherein
the code display part acquires, from the path database, a control path(s) that includes the focused base point(s) and a propagation path(s) between the focused base point(s) and an immediately preceding base point(s) in the control path(s), acquires a portion(s) of code corresponding to the propagation path(s) from the code database, and displays the acquired code.

### [Supplementary Note 3]

The process flow visualization apparatus according to Supplementary Note 1 or 2, wherein
the code display part displays a list of base points used to select the focused base point(s).

### [Supplementary Note 4]

The process flow visualization apparatus according to any one of Supplementary Notes 1 to 3, wherein base point(s) in the control path(s) includes the start point(s), the end point(s), or control instruction(s).

### [Supplementary Note 5]

The process flow visualization apparatus according to any one of Supplementary Notes 2 to 4, wherein the code display part displays, in highlight, variable(s) in the portion(s) of code that are dependent on each variable in the propagation path(s).

### [Supplementary Note 6]

The process flow visualization apparatus according to Supplementary Note 5, wherein the code display part acquires, from the propagation path(s), variable(s) that are dependent on variable(s) selected in the portion(s) of code, and displays, in highlight, the acquired variable(s) along with a portion(s) of code corresponding to an immediately preceding variable in the dependency.

### [Supplementary Note 7]

A process flow visualization method, performed by an information processing apparatus comprising a path database that stores control path(s) between a start point(s) and an end point(s) in a program(s) and propagation path(s) between two base points in the control path(s), a code database that stores code having an association(s) with each element stored in the path database; and a code display part, the process flow visualization method comprising:
acquiring propagation path(s) relevant to focused base point(s) from the path database; and
extracting part(s) of code from the code database based on the propagation path(s) and displaying the extracted code on the code display part.

### [Supplementary Note 8]

The process flow visualization method according to Supplementary Note 7, acquiring, from the path database, a control path(s) that includes the focused base point(s) and a propagation path(s) between the focused base point(s) and an immediately preceding base point(s) in the control path(s), acquiring a portion(s) of code corresponding to the propagation path(s) from the code database, and displaying the acquired code on the code display part.

### [Supplementary Note 9]

A process flow visualization program, executed by an information processing apparatus comprising a path database that stores control path(s) between a start point(s) and an end point(s) in a program(s) and propagation path(s) between two base points in the control path(s), a code database that stores code having an association(s) with each element stored in the path database; and a code display part, the process flow visualization program causing the information processing apparatus to execute: a process of acquiring propagation path(s) relevant to focused base point(s) from the path database; and a process of extracting part(s) of code from the code database based on the propagation path(s) and displaying the extracted code on the code display part.

### [Supplementary Note 10]

The process flow visualization program according to Supplementary Note 9, causing the information processing apparatus to execute: a process of acquiring, from the path database, a control path(s) that includes the focused base point(s) and a propagation path(s) between the focused base point(s) and an immediately preceding base point(s) in the control path(s); and a process of acquiring a portion(s) of code corresponding to the propagation path(s) from the code database and displaying the acquired code on the code display part.

Further, the disclosure of Patent Literature cited above is incorporated herein in its entirety by reference thereto. It is to be noted that it is possible to modify or adjust the example embodiments or examples within the scope of the whole disclosure of the present invention (including Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including Claims, and the technical concept of the present invention. Particularly, any numerical values or ranges disclosed herein should be interpreted that any intermediate values or subranges falling within the disclosed ranges are also disclosed even without explicit recital thereof. In addition, using some or all of the disclosed elements in each literature cited above as necessary in combination with the elements described herein as part of the disclosure of the present invention in accordance with the object of the present invention shall be considered to be included in the disclosed elements of the present application.

### REFERENCE SIGNS LIST

10: flow visualization apparatus
11: path database
12: code database
13: code display part
20: information processing apparatus
21: CPU
22: primary storage device
23: auxiliary storage device
24: IF part

What is claimed is:

1. A process flow visualization apparatus, comprising:
a path database that stores control path(s) between a start point(s) and an end point(s) in a program(s) and propagation path(s) between two base points in the control path(s);
a code database that stores code having an association(s) with each element stored in the path database; and
a code display that acquires propagation path(s) relevant to focused base point(s) from the path database, extracts part(s) of code from the code database based on the propagation path(s), and displays the extracted code.

2. The process flow visualization apparatus according to claim 1, wherein
the code display acquires, from the path database, a control path(s) that includes the focused base point(s) and a propagation path(s) between the focused base point(s) and an immediately preceding base point(s) in the control path(s), acquires a portion(s) of code corresponding to the propagation path(s) from the code database, and displays the acquired code.

3. The process flow visualization apparatus according to claim 1, wherein
the code display displays a list of base points used to select the focused base point(s).

4. The process flow visualization apparatus according to claim 1, wherein base point(s) in the control path(s) includes the start point(s), the end point(s), or control instruction(s).

5. The process flow visualization apparatus according to claim 2, wherein the code display part displays, in highlight, variable(s) in the portion(s) of code that are dependent on each variable in the propagation path(s).

6. The process flow visualization apparatus according to claim 5, wherein the code display acquires, from the propagation path(s), variable(s) that are dependent on variable(s) selected in the portion(s) of code, and displays, in highlight, the acquired variable(s) along with a portion(s) of code corresponding to an immediately preceding variable in the dependency.

7. A process flow visualization method, performed by an information processing apparatus comprising a path database that stores control path(s) between a start point(s) and an end point(s) in a program(s) and propagation path(s) between two base points in the control path(s), a code database that stores code having an association(s) with each element stored in the path database; and a code display part, the process flow visualization method comprising:
acquiring propagation path(s) relevant to focused base point(s) from the path database; and
extracting part(s) of code from the code database based on the propagation path(s) and displaying the extracted code on the code display part.

8. The process flow visualization method according to claim 7, acquiring, from the path database, a control path(s) that includes the focused base point(s) and a propagation path(s) between the focused base point(s) and an immediately preceding base point(s) in the control path(s), acquiring a portion(s) of code corresponding to the propagation path(s) from the code database, and displaying the acquired code on the code display.

9. A non-transitory computer readable medium storing a process flow visualization program, executed by an information processing apparatus comprising a path database that stores control path(s) between a start point(s) and an end point(s) in a program(s) and propagation path(s) between two base points in the control path(s), a code database that stores code having an association(s) with each element stored in the path database; and a code display-part, the process flow visualization program causing the information processing apparatus to execute:
a process of acquiring propagation path(s) relevant to focused base point(s) from the path database; and
a process of extracting part(s) of code from the code database based on the propagation path(s) and displaying the extracted code on the code display-part.

10. The non-transitory computer readable medium storing the process flow visualization program according to claim 9, causing the information processing apparatus to execute: a process of acquiring, from the path database, a control path(s) that includes the focused base point(s) and a propagation path(s) between the focused base point(s) and an immediately preceding base point(s) in the control path(s); and a process of acquiring a portion(s) of code corresponding to the propagation path(s) from the code database and displaying the acquired code on the code display.

11. The process flow visualization method according to claim 7, wherein the code display displays a list of base points used to select the focused base point(s).

12. The process flow visualization method according to claim 7, wherein base point(s) in the control path(s) includes the start point(s), the end point(s), or control instruction(s).

13. The process flow visualization method according to claim 8, wherein the code display displays, in highlight, variable(s) in the portion(s) of code that is dependent on each variable in the propagation path(s).

14. The process flow visualization method according to claim 13, wherein the code display acquires, from the propagation path(s), variable(s) that is dependent on variable(s) selected in the portion(s) of code, and displays, in highlight, the acquired variable(s) along with a portion(s) of code corresponding to an immediately preceding variable in the dependency.

15. The non-transitory computer readable medium storing the process flow visualization program according to claim 9, wherein the code display displays a list of base points used to select the focused base point(s).

16. The non-transitory computer readable medium storing the process flow visualization program according to claim 9, wherein base point(s) in the control path(s) includes the start point(s), the end point(s), or control instruction(s).

17. The non-transitory computer readable medium storing the process flow visualization program according to claim 10, wherein the code display displays, in highlight, variable(s) in the portion(s) of code that is dependent on each variable in the propagation path(s).

18. The non-transitory computer readable medium storing the process flow visualization program according to claim 17, wherein the code display acquires, from the propagation path(s), variable(s) that is dependent on variable(s) selected in the portion(s) of code, and displays, in highlight, the acquired variable(s) along with a portion(s) of code corresponding to an immediately preceding variable in the dependency.
